(19) United States
(12) Patent Application Publication
(10) Pub. No.: US 2006/0005128 A1
(43) Pub. Date: Jan. 5, 2006

(54) E-mail launchpad

(76) Inventors: Tobias Haug, Heidelberg (DE); Karen A. Gee, Heidelberg (DE)

Correspondence Address: KENYON & KENYON, ONE BROADWAY, NEW YORK, NY, 10004, US

(21) Appl. No.: 11/026,025

(22) Filed: Jan. 3, 2005

Related U.S. Application Data
(60) Provisional application No. 60/584,277, filed on Jun. 30, 2004.

(51) Int. Cl. G06F 15/00; G06F 17/00

(52) U.S. Cl. 715/530; 715/752; 707/3; 707/104.1

(57) ABSTRACT

The present invention provides a system and method for displaying an expanded e-mail header of an e-mail message that is readily viewable when reading a received message. An e-mail application retrieves data stored in one or more contact files, such as a sender's contact data and displays this information in an expanded e-mail header or other image within the e-mail so that the recipient can view it by simply clicking on the received e-mail or a received request for an appointment.

### BACKGROUND

Businesses often rely on electronic communications to convey information. Electronic mail (e-mail) is one form of electronic communication that is often used. E-mail messages may be sent from one individual to another to convey information. These messages are often saved by recipients to provide a record of the information conveyed. Additionally, appointment requests may be sent to individuals to request their participation in a meeting, telephone conference or video conference. To ease the use of these services e-mail computer programs have tools that are used to simplify transmission of e-mails and appointment requests. For example, some e-mail computer programs include a contacts folder that stores contact information, such as e-mail addresses, business addresses and telephone numbers of individuals who are frequently communicated with. This allows users to access a record of this information without going to another system or tracking this information manually. E-mail computer programs may also automatically dial a telephone number that is listed in a contacts folder.

E-mail services and tools may not be fully integrated in a manner that is useful for an e-mail user. For example, e-mail messages and appointment requests may contain a cryptic e-mail address of the sender and no other identification information. A recipient of an e-mail may need to look-up this information in a contacts folder. This requires extra steps of clicking to navigate to the contacts folder, identifying the correct individual and then clicking on that individual to display the identification information. Additionally, the user loses a view of the e-mail when looking at information stored in the contacts folder. The user must navigate back to the e-mail message to review the message contents. An individual may also have to go into the contacts folder to view the telephone number of an individual and to have it automatically dialed. Often a user is reviewing an e-mail when the user wishes to see the identification information of the sender or wishes to call the sender. The added steps of going into the contacts folder to make use of the e-mail tools is cumbersome. What is needed is better integration between a received e-mail message and the information in the contacts folder.

### BRIEF DESCRIPTION OF THE DRAWINGS

FIG. 1 depicts an image display flow diagram according to one embodiment of the invention.

FIG. 2 shows an operation performed to display an expanded e-mail header according to one embodiment of the invention.

FIG. 3 illustrates a display of an expanded business e-mail header according to one embodiment of the invention.

FIG. 4 illustrates an e-mail network according to one embodiment of the invention.

FIG. 5 illustrates an e-mail engine according to one embodiment of the invention.

### DETAILED DESCRIPTION

The present invention provides a system and method for displaying an expanded e-mail header of an e-mail message that is readily viewable when reading a received message. An e-mail application retrieves data stored in one or more contact files, such as a sender's contact data and displays this information in an expanded e-mail header or other image within the e-mail so that the recipient can view it by simply clicking on the received e-mail or a received request for an appointment.

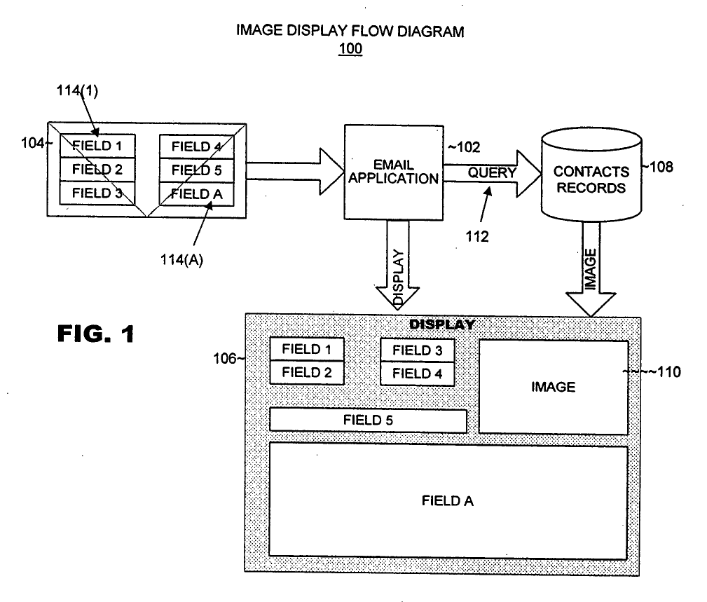

FIG. 1 depicts an image display flow diagram 100 according to one embodiment of the invention. An incoming e-mail 104 is received by e-mail application 102 in, for example, an inbox of a recipient. E-mail application 102 sends a query 112 to contacts records 108. Contacts records 108 uses information received in query 112 to retrieve additional data for an image 110 to be displayed, for example, in the form of an expanded e-mail header. Image 110 is included in a display 106 of the received e-mail 104 so that the recipient of the e-mail does not need to navigate to a separate view to see this information.

E-mail 104 may be any electronic mail message, appointment request, Short Message Service (SMS) text message, Multimedia Messaging Service (MMS) text message, or any other electronic communication that is sent from any source to a destination. Sources and destinations may include individuals, businesses, mailing lists or mailboxes. E-mail 104 may be transmitted according to a format recommended by a standards-setting organization, such as the Internet Engineering Task Force (IETF). This format may provide for a header portion that includes various fields, such as the sender's e-mail address, the date sent, and the e-mail addresses of recipients of the e-mail message, and a body portion, which includes text of the message. E-mail 104 may comprise multiple fields 114(1)-114(A).

E-mail application 102 may be any program that is used to transmit and receive e-mail messages or create appointments, such as a Microsoft Outlook e-mail program, SMS or MMS text message programs available with cellular phones, or any other e-mail program. Contact information, such as a sender's e-mail address, may be retrieved a field 114 of e-mail 104 and sent in query 112 to contacts records 108. Contacts records 108 may be any set of data stored in a machine-readable medium. Contacts records 108 may be a look-up table that is keyed off of the contact information that was transmitted in query 112. This contact information or key transmitted in query 112 may be used to retrieve image 110. Contacts records 108 may be stored locally within a contacts folder of e-mail application 102. In an alternate embodiment of the invention, contacts records 108 is an external file in, for example, HyperText Markup Language (HTML) format that may be stored on the World Wide Web or on a server. E-mail application 102 may access contacts records 108 by a link provided in e-mail application 102 that allows access to this external file. Contacts records 108 stores data that will be displayed as image 110 within, for example, an expanded e-mail header.

Display 106 may be any mechanism for providing data to a user, such as a graphical user interface displayed by, for example, a personal computer, or any other mechanism for providing information used by a computer, cellular telephone, personal data assistant or any other electronic device. Display 106 may provide to the user in viewable or otherwise recognizable format information included in fields 114(1)-114(A) that were transmitted by e-mail 104. Included in display 106 may be image 110.

Image 110 may be any output for providing contact data to a user that may be viewed with email 104. This additional contact data may comprise a sender's telephone number, employer, address, and/or facsimile (FAX) number. This additional data may be provided as fields, in an image in the form of a business card, or any other format that is recognizable to a recipient of e-mail 104. Image 110 may include a logo of the sender's employer.

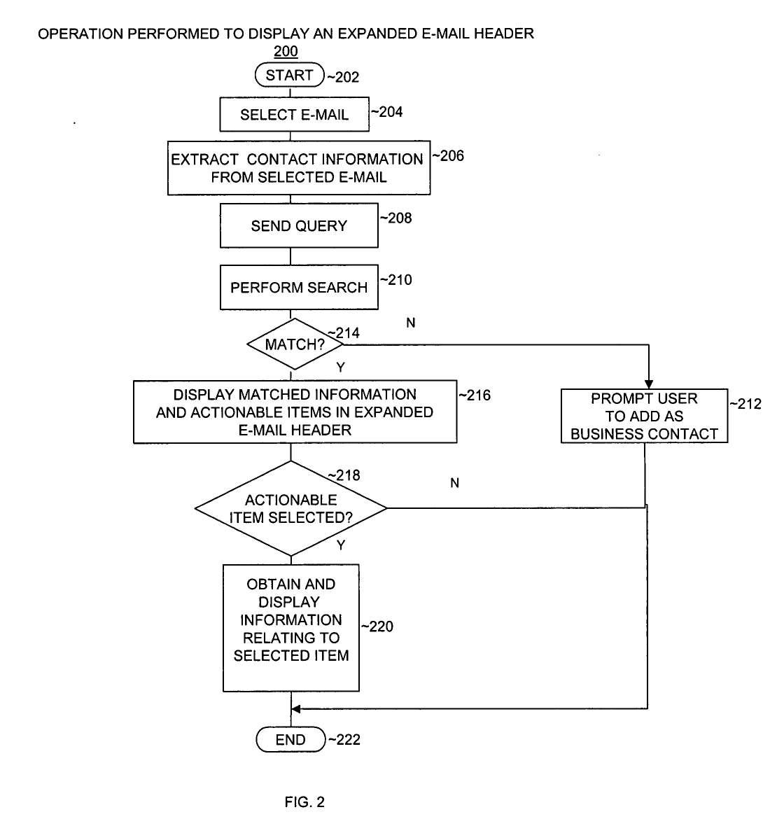

FIG. 2 shows an operation performed to display an expanded e-mail header according to one embodiment of the invention. In step 204, an e-mail 104 is selected by a user of e-mail application 102. A user may select an e-mail 104 from a folder, such as an inbox.

In step 206, upon receipt of a selection, contact information or a key may be extracted from the selected e-mail 104. For example, if e-mail 104 is transmitted in accordance with a format recommended by the IETF, the e-mail may comprise a header portion of the e-mail and a body portion, which includes text of the message. The e-mail message may be parsed in accordance with the format used for transmission to extract the appropriate field, such as the sender's e-mail address, from the header portion of the e-mail. The sender's domain may also be extracted, which may indicate the computer system serving the sender. In an alternate embodiment of the invention, contact information retrieved from the body of the e-mail may be used as a key to retrieve additional data. For example, contact information stored in a signature block may be retrieved.

In step 208, a query 112 is sent to file 108 to extract additional data, such as expanded identification information, that may be viewed as image 110 with email 104. By sending a query to contacts records 108 e-mail application 102 is able to display data with e-mail 104 that is not typically viewable by selecting and viewing e-mail 104. Contacts records 108 may be stored locally, on the World Wide Web or on another server.

In step 210, a search is performed within contacts records 108 using the key sent in query 112. Contacts records 108 may be an array comprising a set of fields for each contact. The set of fields may include a field for the sender's e-mail address and additional fields comprising corresponding expanded identification information. The key may be a sender's e-mail address that was retrieved from the e-mail header. This may be compared to contents of each of the fields containing a sender's name in contacts records 108. In step 214, a determination is made of whether a match is found. If no match is found, the user may be prompted to add the sender as a business contact, as reflected by step 212. After a user completes the prompted information, processing may be complete, as reflected by step 222.

If a match is found, processing proceeds to step 216 and image 110, which may comprise expanded identification information corresponding to the sender is displayed. Expanded identification information may be displayed in the form of a business card in an expanded header of the e-mail. A logo of the company may be stored in contacts records 108 as part of the expanded identification information. This logo may also be displayed.

In an alternate embodiment of the invention, actionable items may also be displayed in the e-mail header. Image 110 may display these actionable items may be displayed in the form of controls that allow a user to select a particular actionable item to be performed. These controls may be linked to other modules of e-mail application 102 so that the actionable functions that are selected may be performed by e-mail application 102. An exemplary actionable item is to have e-mail application 102 automatically dial the telephone number of a sender of an e-mail. A control allowing a recipient of an e-mail to select to dial a sender's telephone number may be included in image 110.

In step 218, a determination is made whether an actionable item has been selected. If no actionable item is selected, processing is complete, as reflected by step 222. If an actionable item is selected, processing proceeds to step 220. In step 220, that actionable item may be performed. For example, if a recipient selects to automatically dial the sender's telephone number, e-mail application 102 may dial the sender's telephone by linking to dialing capability provided by e-mail application 102. Controls provided by image 110 may link to other functions provided by e-mail application 102. Exemplary other functions include creation of a business appointment, view of customer details, and start of a follow-up activity. Links may be provided locally or to external systems to cause these functions to be performed. For example, a link may be included to an HTML file residing on the World Wide Web or an external server to start a follow-up activity that is processed by a backend system.

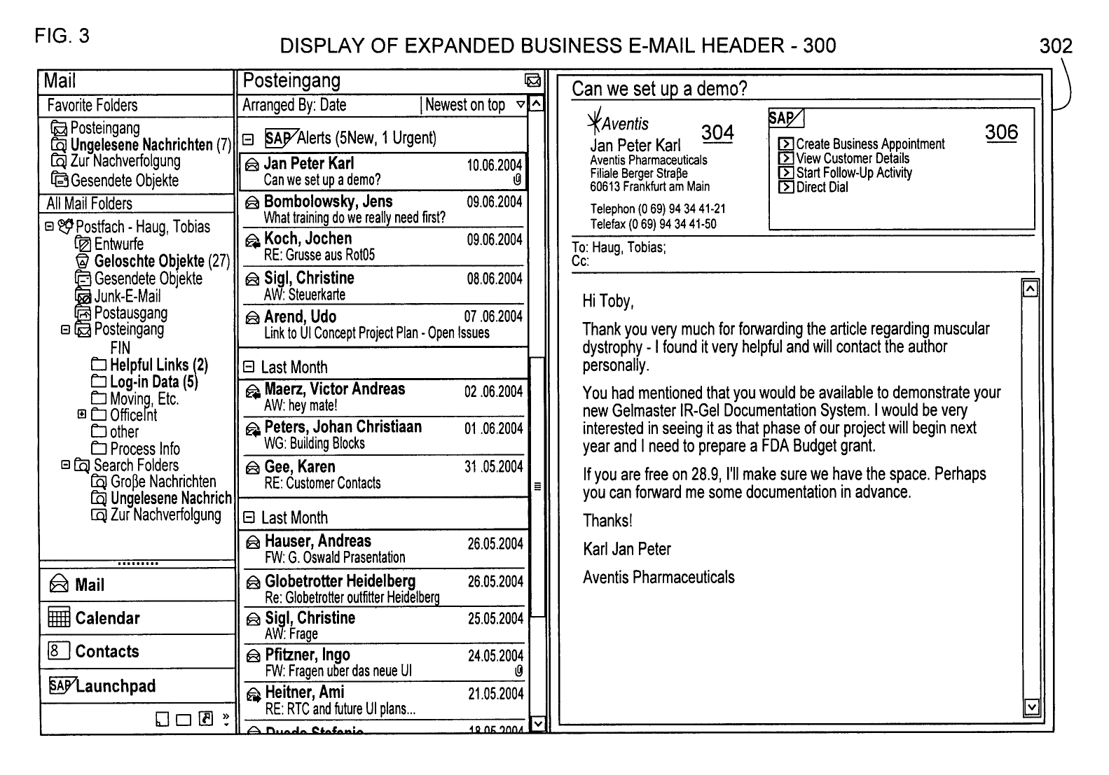

FIG. 3 illustrates a display of an expanded business e-mail header 302 according to one embodiment of the invention. Expanded business e-mail header 302 is formatted in a manner that may be useful for communications between businesses. The expanded business e-mail header 302 contains expanded identification information displayed in the form of a business card 304, including the logo of the sender's company. Additionally, expanded business e-mail header 302 may include business actionable items 306 that may be tailored to business requirements. For example, a user may want to schedule a business appointment by using a create business appointment control. Selection of the create business appointment control may bring a user to an appointment module within the e-mail program. As another example, a user may want to view customer details, start a follow-up activity or initiate a direct dial to the sender. The user may select the appropriate control to provide these functions. Viewing customer details may allow a user to see additional information about the sender's company, such as information about other employees of the company. Starting a follow-up activity may be used to schedule a follow-up activity resulting from the e-mail, such as setting an action in the user's task folder to remind the user to complete an action requested in the e-mail. The direct dial control may be selected to directly dial the sender's telephone number so that the user can speak to the sender.

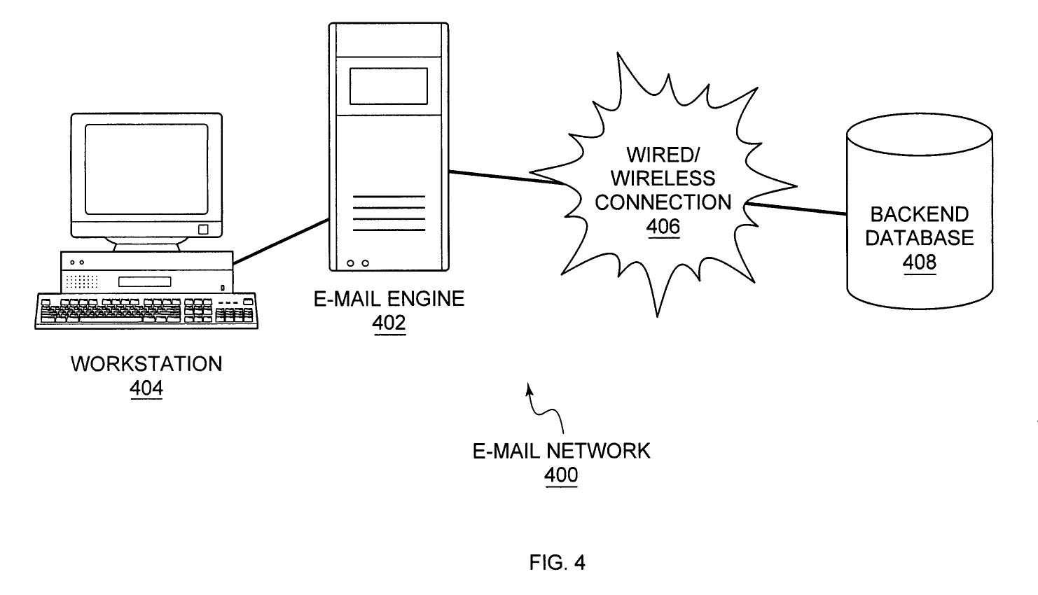

FIG. 4 illustrates an e-mail network according to one embodiment of the invention. E-mail network 400 may comprise and e-mail engine 402 that processes incoming e-mails and displays image 110. E-mail engine 402 may be connected to workstation 404 to display to a user a graphical user interface including image 110. In alternate embodiments of the invention, e-mail engine 402 may be connected to any device that can be used to receive e-mails including a cellular telephone or personal data assistant. Additionally, e-mail engine 402 may be connected to backend database 408 via wired/wireless connection 406.

Workstation 404 may be used to view incoming e-mails and to view enhanced identification information 110. Workstation 404 may also display to users enhanced identification information in the form of expanded search queries. Workstation 404 may be any programmable processor connected to a machine-readable medium that can provide a user interface such as a computer having a graphical user interface (GUI), a phone, or a personal data assistant. Such devices may comprise an output device that can provide to a user any form of sensory feedback such as voice, auditory or tactile (e.g., liquid crystal display (LCD), cathode ray tube (CRT), or earpiece) and an input device providing any form of input to the computer including acoustic, speech, or tactile input (e.g., keyboard, mouse, trackball, keypad).

Backend databases 408 may be any data stored on any machine-readable medium including any computer program product, apparatus and/or device (e.g., a random access memory (RAM), read only memory (ROM), magnetic disk, optical disk, programmable logic device (PLD), tape or any combination of these devices) that are not included within e-mail application 102. Exemplary backend databases 408 include the World Wide Web, external servers and/or application databases. Backend database 408 may be stored according to any file format that may be used to organize data.

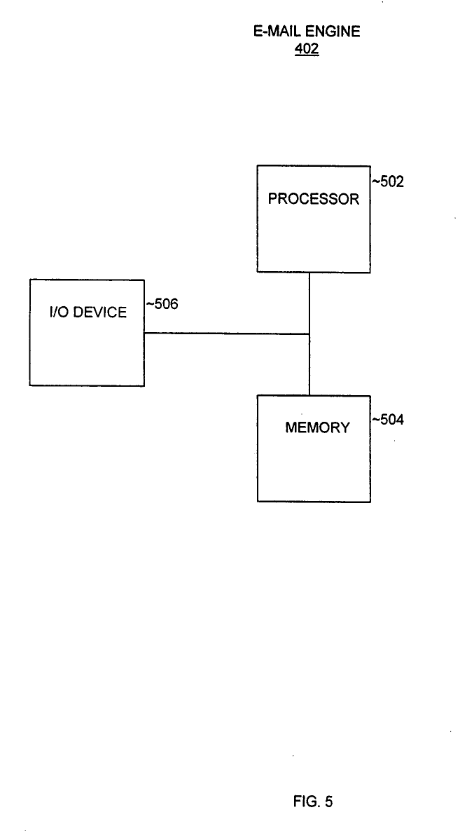

FIG. 5 illustrates an e-mail engine according to one embodiment of the invention. E-mail engine 402 includes processor 502, memory 504, and I/O device 506. Processor 502 is connected to memory 504. Processor 502 is also connected to I/O device 506. These connections are direct or via other internal electronic circuitry or components.

Processor 502 may be any programmable processor that executes instructions residing in memory 504 to receive and send data via I/O device 506 including any programmable microprocessor or combination of microprocessors or processors that can operate on digital data, which may be special or general purpose processors coupled to receive data and instructions from, and to transmit data and instructions to, a machine-readable medium. According to one embodiment of the present invention processor 502 is an Intel microprocessor.

Memory 504 may be any machine-readable medium that stores data that is processed by processor 502 including any computer program product, apparatus and/or device (e.g., a random access memory (RAM), read only memory (ROM), magnetic disc, optical disc, programmable logic device (PLD), tape, or any combination of these devices). This may include external machine-readable mediums that are connected to processor 502 via I/O device 506. I/O device 506 may be any coupling that can be used to receive and/or send digital data to and from an external device.

Various implementations of the systems and techniques described here can be realized in any processing systems and/or digital electronic circuitry, integrated circuitry, specially designed ASICs (application specific integrated circuits), computer hardware, firmware, software, and/or combinations thereof.

A number of embodiments of the invention have been described. Nevertheless, it will be understood that various modifications may be made without departing from the spirit and scope of the invention.

What is claimed is:

1. A method for displaying expanded identification information in an e-mail program comprising:
extracting contact information from an e-mail to be displayed;
querying a contacts data store with the extracted information; and
when a query response provides supplemental contact information, displaying contents of the e-mail in a presentation that integrates the supplemental contact information therewith.

2. The method of claim 1 wherein the extracted information comprises an e-mail address of a source of the e-mail.

3. The method of claim 1 wherein the extracted information comprises a domain name of a source e-mail address.

4. The method of claim 1 wherein the extracted information is retrieved from a body portion of the e-mail.

5. The method of claim 4 wherein the extracted information is retrieved from a signature block.

6. The method of claim 1 wherein the supplemental information comprises a company logo.

7. The method of claim 1 wherein the supplemental information comprises a company name and address.

8. The method of claim 1 wherein the supplemental information is displayed in the form of a business card and includes a company name, address, and logo.

9. In a groupware application, a graphical user interface displaying expanded identification information comprising:
a first spatial area of display to display content of an e-mail received from a source; and
a second spatial area of display to display supplemental identification information retrieved from a contact data store using contact information extracted from the e-mail.

10. The graphical user interface of claim 9, wherein said supplemental information comprises a company logo.

11. The graphical user interface of claim 9, wherein the supplemental information comprises a company name and address.

12. The graphical user interface of claim 9, wherein the supplemental information is displayed in the form of a business card and includes a company name, address, and logo.

13. A computer readable medium storing thereon program instructions that, when executed, cause an executing device to:
extract contact information from an e-mail to be displayed;
query a contacts data store with the extracted information; and
when a query response provides supplemental contact information, display contents of the e-mail in a presentation that integrates the supplemental contact information therewith.

14. The computer readable medium of claim 1 wherein the extracted information comprises an e-mail address of a source of the e-mail.

15. The computer readable medium of claim 1 wherein the extracted information comprises a domain name of a source e-mail address.

16. The computer readable medium of claim 1 wherein the extracted information is retrieved from a body portion of the e-mail.

17. The computer readable medium of claim 4 wherein the extracted information is retrieved from a signature block.

18. The computer readable medium of claim 1 wherein the supplemental information comprises a company logo.

19. The computer readable medium of claim 1 wherein the supplemental information comprises a company name and address.

20. The computer readable medium of claim 1 wherein the supplemental information is displayed in the form of a business card and includes a company name, address, and logo.
